(19) United States
(12) Patent Application Publication
(10) Pub. No.: US 2017/0369676 A1
(43) Pub. Date: Dec. 28, 2017

(54) THERMALLY-RESPONSIVE OPTICAL SWITCHING COMPOSITES FOR THERMAL OPTICAL APPLICATIONS

(71) Applicant: BATTELLE MEMORIAL INSTITUTE, Richland, WA (US)

(72) Inventors: David M. Reed, Richland, WA (US); Matthew P. Westman, West Richland, WA (US); Kevin L. Simmons, Kennewick, WA (US)

(73) Assignee: BATTELLE MEMORIAL INSTITUTE, Richland, WA (US)

(21) Appl. No.: 15/189,293

(22) Filed: Jun. 22, 2016

(51) Int. Cl. C08K 3/40; E04D 1/30; E04F 13/072; E06B 9/24

(52) U.S. Cl. CPC C08K 3/40; E06B 9/24; E04D 1/30; E04F 13/072

(57) ABSTRACT

The current invention is a composite material and a method for making a material that changes an optical characteristic by utilizing the temperature dependent intrinsic properties of at least two phases in the composite. With changes in temperature, these composites become translucent due to the refractive index mismatch that is accompanied by interfacial light scattering.

### STATEMENT REGARDING RIGHTS TO INVENTION MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### FIELD OF THE INVENTION

The present invention relates to composite materials that reversibly transition from a transparent state to an opaque state or vice versa as a function of temperature for energy management and other temperature-related applications.

### BACKGROUND OF THE INVENTION

Composite materials are extensively used in electronics, optics, and structural materials sectors principally because collective properties are unique or desired and not found in single-phase materials. The diameter, morphology, volume fraction, and connectivity of phases within the composite material are often used to tailor the desired properties. Transparent structural composites (i.e. glass fiber loaded polymers) have found limited applications because of their tendency to have a very narrow temperature window in which they are transparent. While methods have been proposed and are in use that show an optical switching behavior based on other factors such as thermochromic phase change pigments, electro-chromics with an applied voltage, etc. New composites and processes are needed that provide optical responses in a variety of applications and circumstances. In particular over wide selected ranges and particularly along a selected range of temperatures. The present invention addresses these needs.

### SUMMARY OF THE INVENTION

The current invention is a composite material and a method for making a material that changes an optical characteristic by utilizing the temperature dependent intrinsic properties of at least two phases in the composite. With changes in temperature, these composites become translucent due to the refractive index mismatch that is accompanied by interfacial light scattering. For example, the refractive index variation of polymeric materials with temperature (dη/dT) is often 1-2 orders of magnitude higher than for inorganic glasses. This difference in the (dη/dT) determines the rate of change with temperature of the mismatch in refractive indices and controls the temperature dependent transmission of the composite.

By carefully pairing and selecting materials with refractive indexes (η) and temperature dependence (dη/dT) in a desired range and pairing these first and second materials the selected performance of the composite is created. In one embodiment the optically modifiable composite material is made up of an index-matched phase material having a first material and a second material that has a maximum transparency at a first temperature when a refractive index of the second material matches a refractive index of the first material and an opaque quality at a second temperature when the refractive index of the second material and the refractive index of the first material are not matched results. This composite reversibly transitions between transparent and opaque as temperatures fluctuate thus providing advantages over prior art processes and devices. In some embodiments the first and second materials are intermixed within the composite. In other applications the two are layered, such as a coating on a substrate or otherwise inter disposed. Preferably, the first material therein has a thermo-optic coefficient between about 8E10-5 to about −5E10-3, and the second material has a thermo-optic coefficient between about +5E10-7 to about −8E10-5. In various other arrangements modifications and alterations can take place. In one example the second material comprises glass flakes having a desired size and orientation. These flaked embodiments may be paired and layered or intermixed with a polymer material. Preferably these flakes are ordered as well as being index matched to create a phase material that is made up of less than 50% of the second material by volume. In addition to the thermo-optically tuned first and second materials the composite may also include a tuning agent that tunes the thermal response of the composite as a function of temperature.

In some embodiments a construction material includes such a thermo-optically modifiable composite with an ordered index-matched phase material having a first material and a second material wherein the composite has a maximum transparency at a first temperature when a refractive index of the second material matches a refractive index of the first material and an opaque quality at a second temperature when the refractive index of the second material and the refractive index of the first material are not matched whereby the composite reversibly transitions between transparent and opaque as temperatures fluctuate. In some examples of these composites first and second materials are intermixed within the composite. In other applications the two are layered, such as a coating on a substrate or otherwise inter disposed Preferably, the first material therein has a thermo-optic coefficient between about 8E10-5 to about −5E10-3, and the second material has a thermo-optic coefficient between about +5E10-7 to about −8E10-5. In various other arrangements modifications and alterations can take place. In one example the second material comprises glass flakes having a desired size and orientation. These flaked embodiments may be paired and layered or intermixed with a polymer material such as an epoxy. Preferably the index matched phase material is made up of less than 50% of the second material by volume. In addition to the thermo-optically tuned first and second materials the composite may also include a tuning agent that tunes the thermal response of the composite as a function of temperature. Examples of construction materials that include these composites include windows, doors, wraps, coatings, siding, roofing materials, covers, vents, ducts, paving materials, paints, stains, vehicle parts, textiles and other associated items.

The present description also includes a method of making such an optically modifiable composite material by mixing a preselected amount of a transparent filler material into a preselected quantity of a transparent matrix material filler material to form a composite. In some examples the composite can be further adjusted by tailoring the morphology, loading, particle size of the filler, composite thickness, refractive indices of filler and matrix, and the dr)/dT of the filler and matrix so as to enable the composite to act as a temperature dependent optical switch. These materials are index matched and are tunable so as to allow the refractive indexes to align over a wide temperature range and to shift out of alignment when temperatures or other preselected conditions arise. When this shifting occurs the refractive properties of the materials shift and the material can shift for example from transparent to opaque or from opaque to transparent. In other instances the materials can be tuned so that color, shading, pigmentation or other features can be changed. When the temperature or other external factor returns to the original tailored range, the refractive indexes realign and the material returns to its original state.

Products designed for energy efficiency (i.e. building materials, textiles, etc.) for example, could be designed to go from a transparent absorbing state to an opaque reflecting state with changes in temperature. For example, a black roof with a composite film laminated to the black surface that remains black (and absorbing solar radiation because film is transparent) in cold-cool conditions and slowly transition to opaque with temperature due to the difference in (dη/dT) of matrix and filler. The refractive indices are matched where transparency is desired and less transparent to opaque at other temperatures depending on the difference in (dη/dT) filler particle size, volume fraction, composite thickness, etc.

In another embodiment the index-matched phase material has an ordered second phase with fixed size and aspect ratio. In other embodiments coatings can be placed on the ordered index phased material or on the matrix to tune and alter the refractive indices. Tune-ability of the materials and the ranges can be accomplished by altering or varying the physical structure of the polymer matrix material. In one embodiment these are flakes over a preselected size range. In other embodiments various other shapes, sizes and configurations may also be utilized. Tune-ability of the material can also be accomplished through the use of different materials such as glass, ceramic, other polymers and combinations thereof as well as chemical modification or alteration of the materials so as to alter their reflective indices. Examples of tuning agents include but are not limited to co-polymers; diluents, resins and combinations thereof. The materials and configurations can create novel composite structures that will reversibly change from transparent (or any underlying color) to opaque over a targeted temperature range. The composites can be employed to fabricate inexpensive functional materials that will find applications in a wide variety of applications including the energy management of buildings, vehicles, and consumer markets.

The purpose of the foregoing abstract is to enable the United States Patent and Trademark Office and the public generally, especially scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1A shows an example of one embodiment of the present invention.

FIG. 1B illustrates an example of a composite substrate

FIG. 2 shows slope thermo-optic behavior of a number of silicone and glass materials

FIG. 3A shows thermo-optic coefficient (dη/dT) slope lines for exemplary thermo-optical switching composites of the present invention.

FIG. 3B shows various transmission curves representing different thermo-optical switching composites of the present invention.

FIG. 4 shows photographic examples of various embodiments of the present invention.

FIG. 5 plots the thermal response to transmission as a function of filler volume fraction.

FIG. 6 plots the thermal response to transmission as a function film thickness at a fixed volume fraction.

FIG. 7 plots thermal response as a function of filler volume fraction at fixed film thickness.

FIG. 8 shows the results of testing one set of embodiments of the present invention.

FIG. 9 shows the results of testing a second set of embodiments of the present invention.

FIG. 10 shows the results of testing of a third set of embodiments of the present invention.

FIG. 11 plots transmission curves for the Example 3 shown the results of which are shown in FIG. 10.

### DETAILED DESCRIPTION OF THE INVENTION

In the following description, embodiments of the present invention are shown and described by way of illustration of various modes for carrying out the invention. It will be apparent that various modifications, alterations, and substitutions to the present invention may be made. It should be understood that there is no intention to limit the invention to the specific forms disclosed, but, on the contrary, the invention is intended to cover all modifications, alternative constructions, and equivalents falling within the spirit and scope of the invention as defined in the claims. Therefore the description should be seen as illustrative and not limiting.

In an effort to assist the reader in understanding the description provided hereafter the following glossary is provided as a convenience of the parties.

Opaque means the region where the difference between η1 and η2 is greater than 0.01.

Optical Switching refers to the transition of a composite from a transparent state to an opaque state or vice versa as a function of temperature over a selected temperature range.

Refractive Index is the ratio of the velocity of light in a vacuum to the velocity of light in a selected material.

Transparent means the region where the refractive index of the matrix and filler are matched, η1=η2, or difference between η1 and η2≦0.01.

The following description provides examples of composite materials with varying optical characteristics based upon the temperature dependent intrinsic properties of at least two phases in the composite. With changes in temperature, these composites become translucent due to the refractive index mismatch that is accompanied by interfacial light scattering. For example, the refractive index variation of polymeric materials with temperature (dη/dT) is often 1-2 orders of magnitude higher than for inorganic glasses. This difference in the (dη/dT) determines the rate of change with temperature of the mismatch in refractive indices and controls the temperature dependent transmission of the composite.

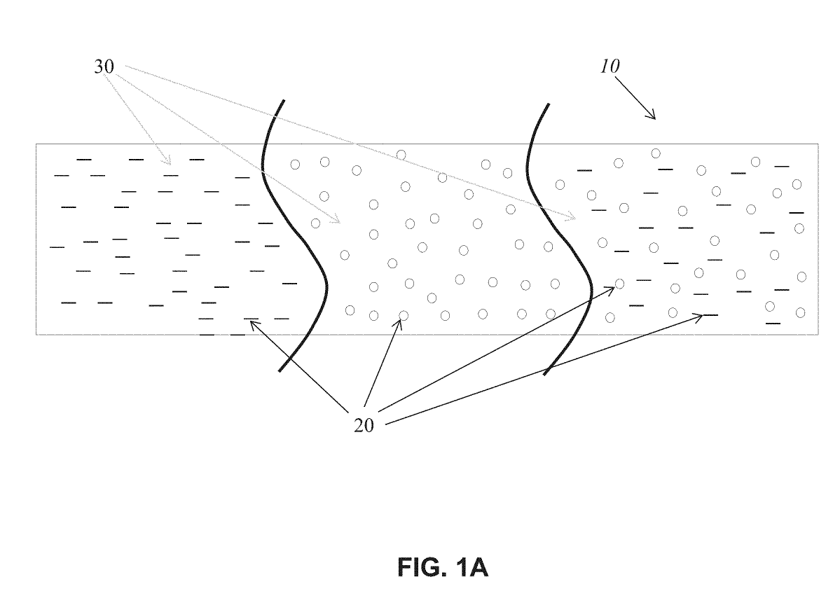

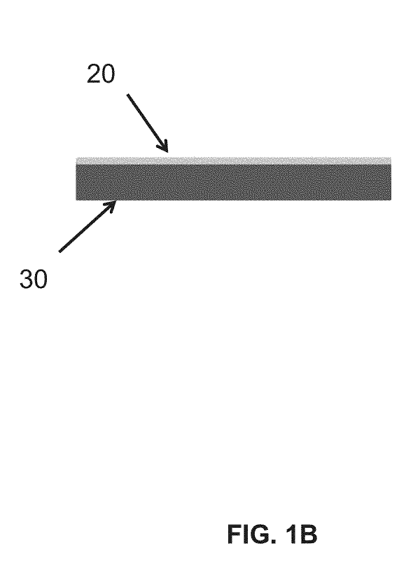

One example of such is an optical filter having an ordered index-matched phase material embedded within a polymer matrix. In this disclosure the materials provide a thermally-responsive optical switching composite that reversibly transitions from a first state, preferably a transparent or first, shaded, pigmented, or colored state to an opaque or second shaded, pigmented or colored state over preselected targeted temperature ranges. Referring first to FIG. 1, a thermal-optical filter 10 of the present invention is shown. The filter 10 is a composite including a selected ratio of a first material 20 that defines a matrix combined with a second material 30 that acts as a filler. In one embodiment of the disclosure the first 20 and second 30 materials are transparent and the second material 30 has a thermo optical coefficient that is different from the thermo optical co-efficient of the first material 20 and when subjected to changes in temperature changes its refractive index changes and the composite 10 appears opaque. When the temperature of the materials returns to the original range the refractive index likewise returns to the transparent range and the filter composite 10 becomes clear again. In one preferred embodiment the first material (matrix) 20 is an expoxy and the second material (filler) 30 are high aspect ratio 15 micron glass flakes that make up a maximum fraction in the matrix material of up to about 50% by volume. In one embodiment the embedded glass flakes 30 are uniformly oriented with respect to the incident light direction will be used to modify the optical properties of the polymer 20. Flake orientation can be controlled by the fabrication process using techniques such as tape casting or extrusion.

In other embodiments the matrix material 20 may be glass particles such as fibers and the filler material 30 a polymer. The filter design strategies proposed here are based on the Christiansen effect of scattering light in a heterogeneous medium comprised of index-matched materials with contrasting temperature dependences. In some embodiments the filters 10 also include an ordered second phase material a fixed size and aspect ratio; a nanometer thick coating on this second phase material can also assist with the tuning and variability of the particular application.

The present invention takes advantage of the ability to adapt the morphology and chemistry of the components (20, 30) so as to alter and control the offsets in the refractive indices so that at a fixed temperature, the filter will reversibly change from transparent to opaque or from opaque to transparent. Transmission and scattering from the composite material 10 can be measured and adapted as functions of flake thickness, particle size, aspect ratio, volume fraction, alignment, and spacing and compared with the predicted response. Alteration of the filler 20 morphology can be used to broaden the transparent temperature window. In some applications the composite 10 can be placed upon a substrate.

For optimum transmission over a large temperature range, the matrix 30 and flake 20 are index matched. As stated earlier, this is achieved by manipulating the polymer and filler chemistry to achieve an index match at some desired temperature. The width of the transparent temperature window can be controlled by the flake aspect ratio. At elevated temperature the composite 10 will become opaque due to the mismatch in the refractive indices. This is referred to as the reversible switching window. Furthermore, a gradual or steep transition can be tailored by adjusting the matrix chemistry. Preferably, the composite includes delivering a matrix material having a thermo-optic coefficient (dn1/dT1) from about −8E10⁻⁵ to about −5E10⁻³, where (dη₁) is the change in refractive index of the matrix material 20 with changes in temperature (dT₁). The filler material 30 used therein preferable has a thermal coefficient (dn2/dT2) selected from about +5E10⁻⁷ to about −8E10⁻⁵, where (dη₂) is the change in refractive index of the filler material with changes in temperature (dT₂). Preferably filler material 30 makes up 50 percent or less of the composite by volume and is generally uniformly dispersed through the matrix. Such devices are intended to operate in a temperature range from −100° C. to about 300° C.

Polymers having different thermal expansion coefficients, or that undergo reversible free volume changes with temperature will force the polymer to elongate at a different rate thereby affecting the rate at which the percent transmission changes for the composite as a function of temperature. This divergence of the refractive index will allow for a steep switching window in contrast to a composite with a slow divergence. Deposition of thin films on glass flake surfaces could also alter composite functionality. For example, IR absorbing materials or interference films that change color with temperature could allow for related cross cutting technologies such as chameleon textiles/optical camouflage.

In other applications the use of this material could provide substantial advantages to the energy, building, military, and consumer electronic markets. Other polymers that would be suitable for use include, but are not limited to the follow polymer classes of, thermosetting polymers, thermoplastic polymers, and elastomers, thermosetting polymers such as, epoxy resins; silicones; polyvinyl esters; polyurethanes; cyanoacrylates; melamine polymers; and combinations of these polymers; thermoplastic polymers, such as polyacrylates; polycarbonates; polyolefins; polynitriles; polyvinyls; and combinations of these various thermoplastic polymers and others. and combinations of these materials. In one set of examples the matrix polymers thermal coefficients between −8E10⁻⁵ to about −8E10⁻³. The overall thicknesses of the composite filters have thicknesses at or below 10 millimeters however these may be altered according to the needs of the user. As such the examples provided above are intended as being exemplary only and are not to be seen as limiting.

Filler materials 30 suitable for use include, but are not limited to, e.g., transparent glass; transparent ceramics; transparent plastics; and combinations of these various filler materials. In some embodiments, the filler material is an inorganic glass selected from E-glass; C-glass; MPR glass; or combinations of these glasses. These may be provided in a variety of forms including but not limited to Forms of the filler material include, but are not limited to, for example, flakes, disks, rods, spheres, pellets, particles, granules, other forms, and combinations of these various forms. Preferably these are dispersed uniformly within the matrix of the composite and have a particle less than about 100 microns.

In some embodiments, transparent filler materials 30 have the form of flakes oriented in the matrix of the composite so as to be aligned along the length dimension on the substrate. In some embodiments, the flakes are oriented orthogonal to the direction of incident electromagnetic wavelengths in order to modify the optical properties of the composite on the substrate. In some embodiments, the flakes of the filler material include an orientation in the matrix substantially parallel to the surface of the composite. In some embodiments, the filler material 30 has an aspect ratio greater than 1 micron. Aspect ratios selected for the filler material control the width of the transparent temperature window of the composite, and the temperature range over which the thermal optical composites transition from a transparent state to an opaque state (the “reversible switching window”) or vice versa.

Various factors influence the thermo-optical coefficients of the matrix and filler materials in the composite, these in turn change the refractive indices and affect the range of temperatures over which the composites transition from the transparent state to the opaque state or vice versa. By modifying the thermo-optical coefficients the respective refractive indices changes and the transition properties of the composite may be tuned for selected applications. Factors that influence the thermo-optic coefficients of the matrix and filter materials in the composite include, but are not limited to, for example, form of the filler material; morphology of the filler material; orientation of the filler material within the matrix; filler particle size; filler aspect ratios; filler quantity (e.g., weight fraction, volume %, or ratio); dispersion (dn/dλ) of the filler material within the matrix; matrix viscosity; presence or absence of secondary or tertiary materials in the composite including, for example, co-polymers, diluents, catalysts, curing agents, like reagents, and/or other additives introduced into the matrix, including combinations of these various factors.

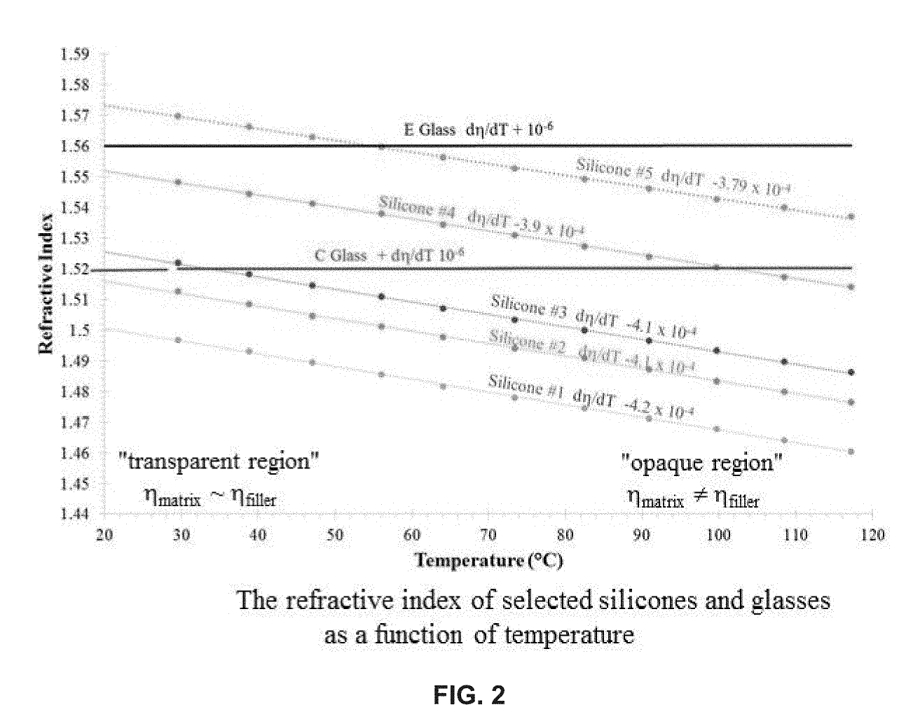

Shown in FIG. 2A are the thermo-optic coefficients of the filler (flat line) and matrix (steeper sloped lines) in one embodiment. The difference in refractive indices (RI) between the matrix and filler determines the optical response as a function of temperature of the composite as shown in FIG. 2B. In some embodiments, for example, slope lines are steeper such that the change in refractive index between the matrix and filler materials is greater with every increase or decrease in temperature. Steeper slope lines reflect a greater change in the RI of the matrix material compared with the RI of the filler material at any given temperature. In some embodiments, slope lines are less steep such that the change in refractive index between the matrix and filler materials is less with every increase or decrease in temperature.

Selection and manipulation of these various factors tailors the transmission of electromagnetic wavelengths (UV, visible, and IR) through the composites for intended or selected applications. Coefficients define the changes in refractive index with changes in temperature for each component within the composite. Thus, each component includes respective line slopes (i.e., descent or ascent) that in combination govern the transition of the composite from the transparent state to the opaque state or vice versa at selected temperatures. Position of the slope lines with respect to temperature (i.e., the temperatures at which the composite transitions) are also affected by such factors. In some embodiments, the matrix material 20 has a thermo-optic coefficient (dη1/dT1) selected from about 8E10-5 to about −5E10-3, where (dη₁) is the change in refractive index of the matrix with changes in temperature (dT1) In some embodiments, the filler material 30 has a thermal coefficient (dη2/dT2) selected from about +5E10-7 to about −8E10-5, where (dη2) is the change in refractive index of the filler with changes in temperature (dT2). In other embodiments other materials show a glass with a thermo-optic coefficient of ˜10-6. The refractive index and thermo-optic coefficient of the matrix material to be tailored relative to the thermo-optic coefficient of the filler material such that the composite is thermally responsive over a selected or desired temperature range. FIG. 2 shows slope lines (dn/dT) corresponding to exemplary composites showing the change in refractive index of the silicone polymers and glass filler materials as a function of changes in temperature (i.e., dη/dT). Data show temperatures of the transparent and opaque states may be selected based on the RI profile selected for the matrix and for the filler material. For example, the composite configured with a matrix of silicone #3 (see RCF 003, TABLE 1) and a C-glass filler has a transparent state at a temperature of about 35° C. and an opaque state above 100° C. The composite thus transitions from a transparent state to an opaque state over a temperature range from about 35° C. to temperatures at or above about 100° C. or greater. As shown in FIG. 2, temperatures for the transparent state of the composite may be tuned with the selection of a suitable filler material with a selected refractive index and thermo-optical coefficient (slope) line.

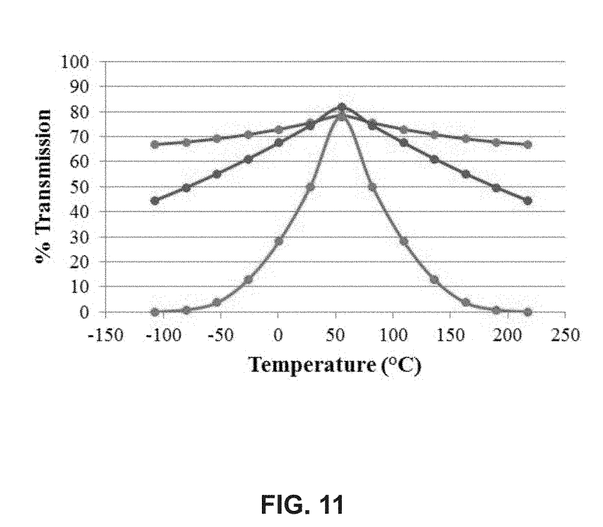

A second opaque state occurs at a temperature of about 190° C. The composite transitions from an opaque state to the transparent state over a temperature range from about −90° C. to about 50° C. A second transition occurs from the transparent state to a second opaque state over a temperature range from about 50° C. to about 190° C. During the second transition, transmission decreases from about 35% at a temperature of 100° C. to about 5% at a temperature of 160° C. The composite containing a filler with a flake size of 160 μm has a wider transition range between the opaque state and the transparent state. For example, at a temperature of 100° C., % transmission is 72%, a decrease of only about 8% from the transparent state. At a temperature of 160 C, % transmission is still about 55% compared to the former composite. The composites containing a filler with a flake size of 600 μm has a yet wider transition range between the opaque state and the transparent state. As observed in FIG. 11 composites made with larger particle sizes have a wider transition range and vice versa. Temperatures of the transparent and opaque states may be selected based on the RI profiles selected for the matrix and for the filler material. For example, the composite comprised of a matrix of silicone #3 and a C-glass filler is transparent at a temperature of about 35° C. and opaque at a temperature above 100° C. The composite thus transitions from a transparent state to an opaque state over a temperature range from about 35° C. to temperatures at or above about 100° C. or greater. As shown, temperatures at which the transparent state of the composite occurs may be tuned by selection of suitable matrix and filler materials with RI values that match at the desired temperatures. Temperature range over which the composite transitions from transparent to opaque or vice versa may be tuned by selection or manipulation of the slopes of the thermal coefficient lines as detailed herein. In one example Thermoplastic pellets were initially ground with a grinder or blender to obtain a fine size (<0.5 mm). The thermoplastic powder was then sieved to −200 mesh. Powders were then collected and stored in an 80° C. oven until use to keep powders dry and remove excess water from the powders. Appropriate amounts of ground thermoplastic powder was then combined with glass powder by dry blending. The mixture was then formed into a free standing composite by 1) hot pressing and/or 2) extrusion. In the hot pressing embodiment, a preheated 1.5-2″ diameter die was removed from an oven and the polymer/filler blend was poured into the hot die. Blend was then pressed to ˜6000 lbs for ˜20 minutes. The pore free composite was then removed from the die. In the extrusion embodiment, the dry-blended mixture of thermoplastic and filler was extruded to form a film with dimensions of 3-6″ in width and a thickness of ˜1-2 mm.

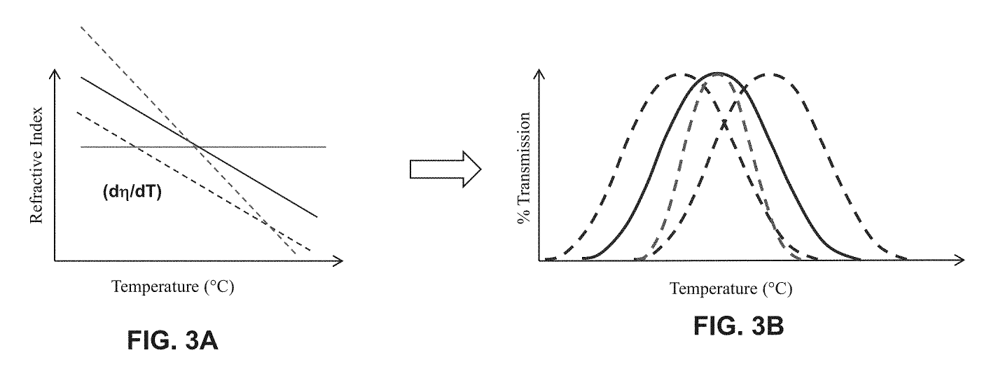

FIGS. 3A and 3B show the changes in RI as a function as a change in temperature and the change in % transmission as a function of temperature respectively. The slope and position of the line in FIG. 3A can be tailored with chemistry and material selection. As disclosed previously, catalysts, co-polymers, and diluents may be added to the composite in various quantities to tune the physical and chemical properties of the composite matrix including, for example, the density, viscosity, and/or molecular structure of the matrix. Additives permit the thermo-optic coefficients of the matrix material to be tailored relative to the thermo-optic coefficients of the filler material such that the composite is thermally responsive over a selected or desired temperature range.

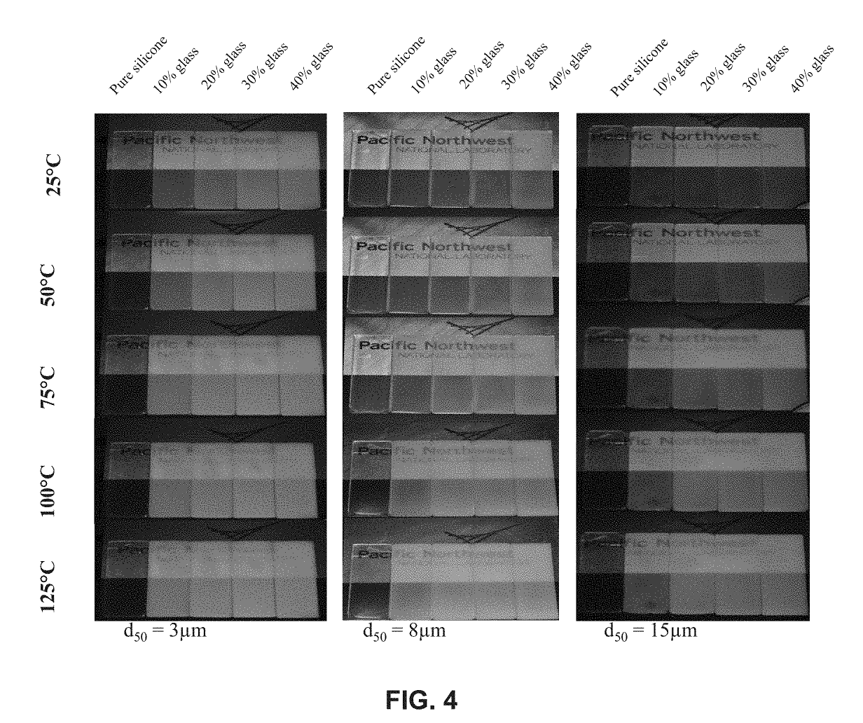

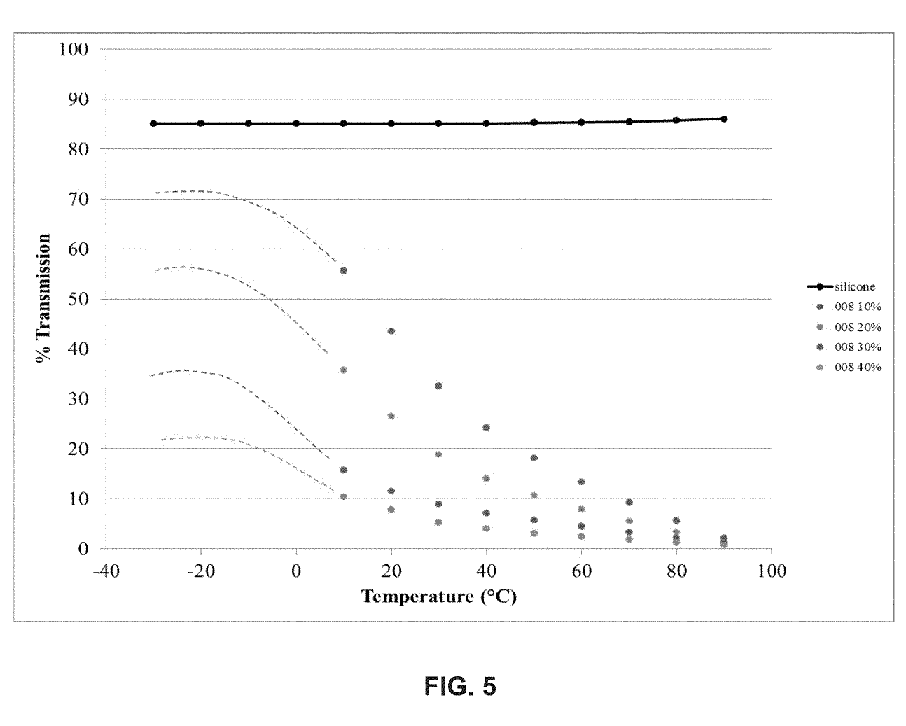

FIG. 4 is a photograph that shows actual changes in % transmission for exemplary composites of the present invention as a function of particle size, filler volume fraction, and particle loading, and changes in temperature over the temperature range from 25° C. to 125° C. FIG. 5 plots the change (i.e., thermal response) in % transmission (400-1100 nanometers) of exemplary composites of the present invention with increasing filler fraction (volume %) as a function of temperature. As shown in the figure, with this silicone matrix, increasing the fraction of filler in the matrix decreases the % transmission of the composite in the transparent region of the composite.

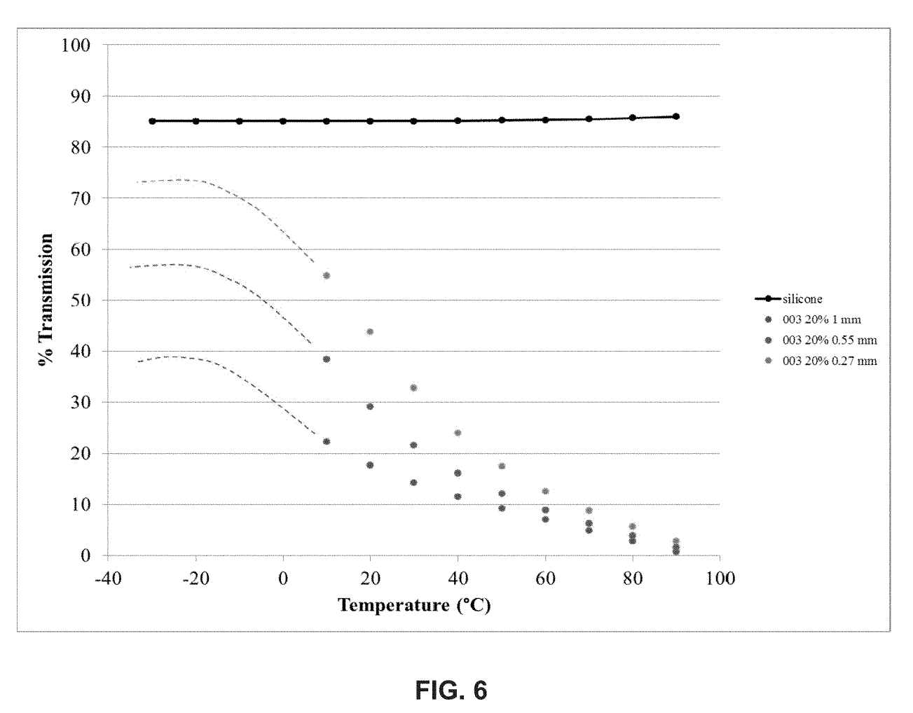

FIG. 6 shows changes in the thermal response (% transmission) (400-1100 nanometers) of exemplary composites of the present invention at a fixed filler fraction (20% volume fraction) as a function of temperature. As shown in the figure, increasing thickness of the composite decreases transmission of light wavelengths through the composite with a consistent temperature for the transparent state and the opaque state.

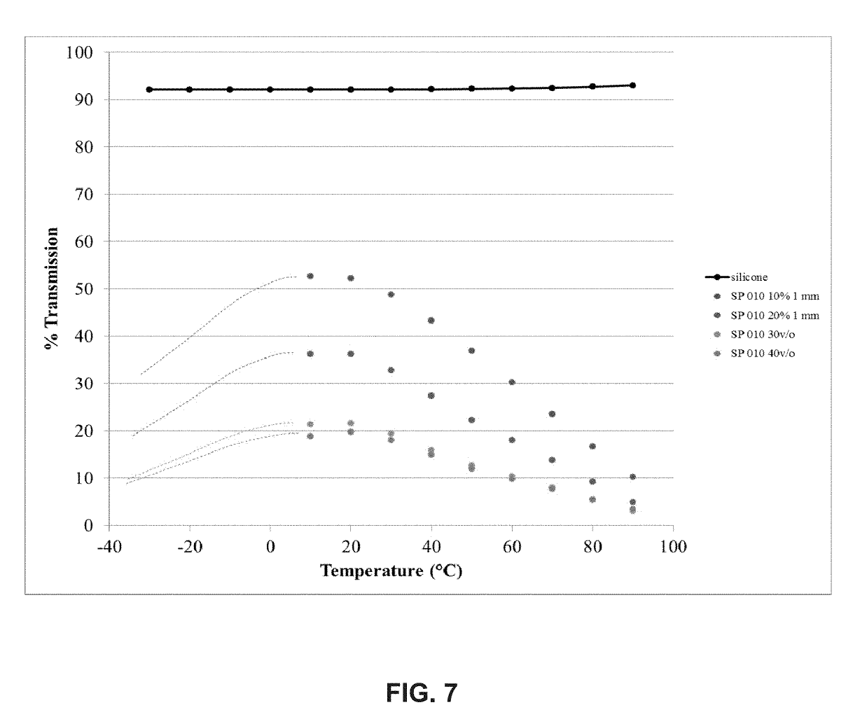

FIG. 7 plots changes in transmission (400-1100 nanometers) of exemplary silicone/glass thermal optical switching composites of the present invention as a function of increasing filler volume fraction at a fixed composite thickness. As shown in the figure, composites with the lowest filler loading show the highest transmission. Composites with the highest filler loading show the lowest transmission. For these composites, temperature for the transparent state is about 10° C. Temperature for the opaque state is above about 90° C.

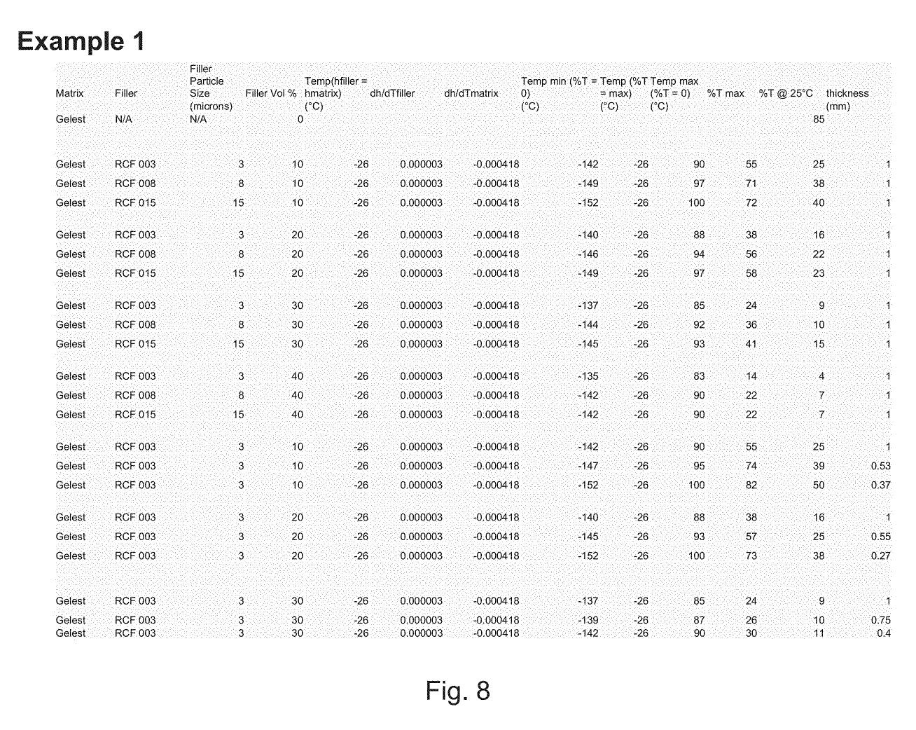

FIGS. 8-10 show the data of various experiments performed and examples of various embodiments of the disclosure.

### Example 1

Various composite films with different refractive indices were prepared using Gelest OE50 silicone as a matrix and RCF glass flake with different particle sizes as a filler material. Composite films were prepared as follows. Appropriate portions of silicone and filler were weighed out to make composites with 10, 20, 30, and 40 volume % filler in the silicone matrix as shown in FIG. 8. The silicone and glass filler were mixed in a planetary mixer for 5 minutes. The mixture was then placed under vacuum to remove remaining air bubbles in the mixture. Samples were then cast into aluminum molds and placed in an oven at 55° C. for 4 hours followed by 150° C. for 1 hour to cure. After curing, samples were removed from the aluminum die to make free standing films for analysis. Samples were cast nominally at 1 mm but also made with different thickness as shown in the table of FIG. 8.

### Example 2

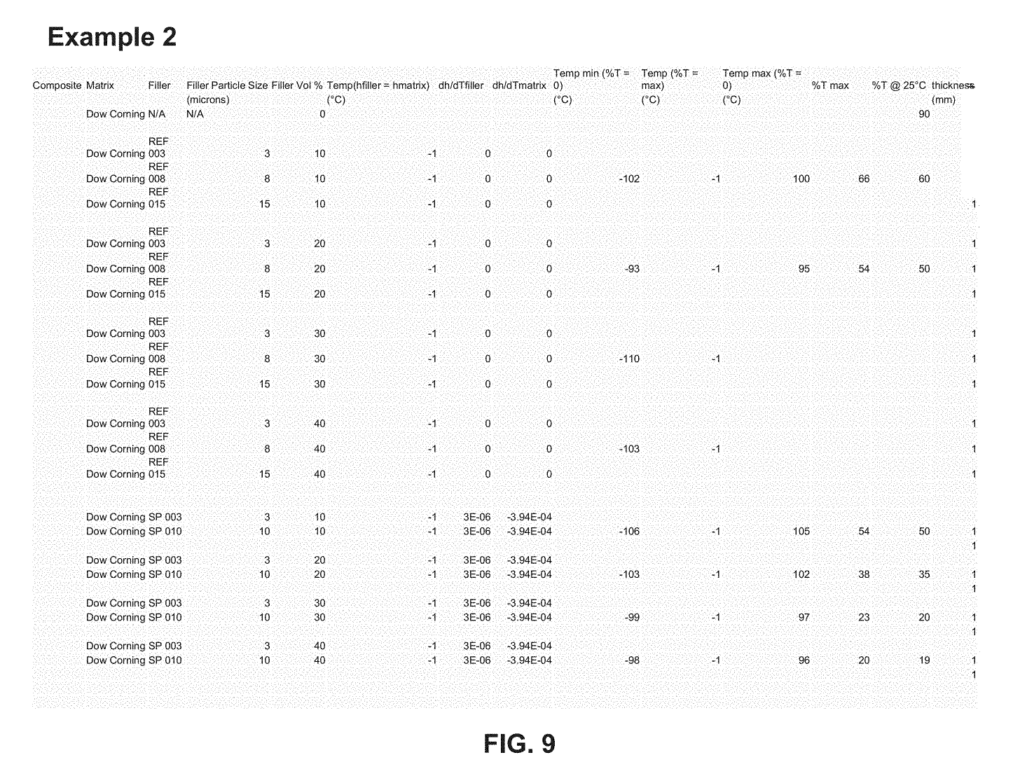

In another set of experiments composite films with different refractive indices were prepared using Dow Corning OE-6550 silicone as a matrix and REF glass flake with different particle sizes as a filler material. Composite films were prepared as follows. Appropriate portions of silicone and filler were weighed out to make composites with 10, 20, 30, and 40 volume % filler in the silicone matrix as shown in FIG. 9. The silicone and glass filler was mixed in a planetary mixer for 5 minutes. The mixture was then placed under vacuum to remove remaining air bubbles in the mixture. Samples were then cast into aluminum molds and placed in an oven at 150° C. for 1 hour to cure the silicone. After curing, samples were removed from the aluminum die to make free standing films for analysis. Samples were cast nominally at 1 mm. Thermal and optical properties of resulting samples were then tested. The results are shown in FIG. 9.

### Example 3

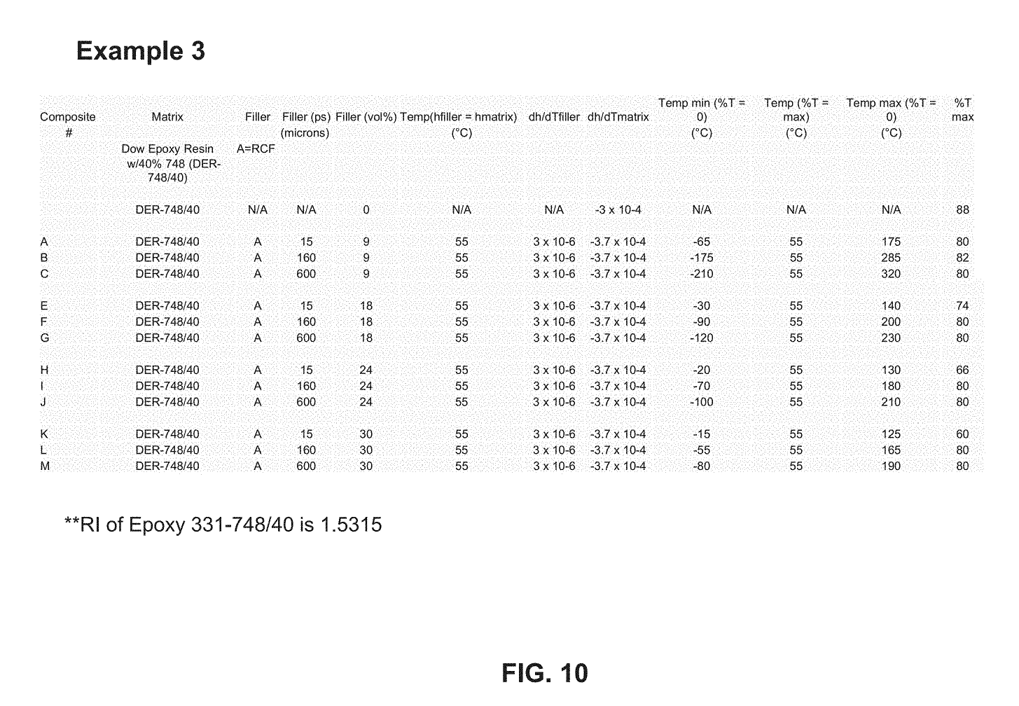

Various composite films with different refractive indices were prepared using Dow Epoxy Resin331 as a matrix and RCF glass flake with different particle sizes as a filler material. Composite films were prepared as follows. Appropriate portions of silicone and filler were weighed out to make composites with 9, 18, 24, and 30 volume % filler in the epoxy matrix as shown in the table of FIG. 10. The epoxy and glass filler were mixed in a planetary mixer for 5 minutes. The mixture was then placed under vacuum to remove remaining air bubbles in the mixture. Samples were then cast into silicone molds and placed in an oven at 80° C. for 1 hour to cure the epoxy. After curing, samples were removed from the silicone die to make free standing films for analysis. Samples were cast nominally at 1 mm. Thermal and optical properties of resulting samples were then tested. Results are shown in FIG. 10.

FIG. 11 shows plots of the transmission curves for composites of the present invention comprised of the epoxy resin and E glass system described in example 3 and shown in FIG. 10. The transmission curves in FIG. 11 are for C-glass at a fixed filler fraction (9% volume) with increasing flake sizes from 15 μm to 600 μm. Results show the composite with a 15 μm filler flake size exhibits a transparent state at a temperature of about 50° C. with a transmission of about 80%. The composite is also opaque at two different temperatures. A first opaque state occurs at a temperature of about −90° C. A second opaque state occurs at a temperature of about 190° C. The composite transitions from an opaque state to the transparent state over a temperature range from about −90° C. to about 50° C. A second transition occurs from the transparent state to a second opaque state over a temperature range from about 50° C. to about 190° C. During the second transition, transmission decreases from about 35% at a temperature of 100° C. to about 5% at a temperature of 160° C.

The composite containing a filler with a flake size of 160 μm has a wider transition range between the opaque state and the transparent state. For example, at a temperature of 100° C., % transmission is 72%, a decrease of only about 8% from the transparent state. At a temperature of 160 C, % transmission is still about 55% compared to the former composite. The composites containing a filler with a flake size of 600 μm has a yet wider transition range between the opaque state and the transparent state. As shown in FIG. 11 composites made with larger particle sizes have a wider transition range and vice versa.

The present invention can be used in a variety of applications including, but not limited to, for example, textiles, coatings, automotive applications, windows and pavement. It can be used as an energy management component in materials used in buildings, in vehicles, and in aircraft, and may be embodied in (e.g., roofing, windows, siding); paints; coatings; optics; sensors; tamper-indicating tags and seals; clothing; smart textiles; road surfaces; consumer electronics; sensors; vehicles, signs; paints; coatings; athletic equipment; outdoor equipment; consumer products; and other applications. Composites may be applied or delivered to various substrates by methods known to those of ordinary skill in the manufacturing and application arts including, but not limited to, for example, spraying, painting, printing, coating, pressing, imprinting, depositing, casting, extruding, molding, pressing, hot pressing, injection molding, sewing, rolling, thermal curing, other applications methods, including combinations of these processes.

A variety of exemplary applications of composite films of the present invention are contemplated. For example, composites of the present invention can be included as a component of a roofing substrate (e.g., a roofing shingle) during manufacture of the roofing substrate, or after installation of the roofing substrate on the intended building as a thermally-responsive, optical switching device. A composite so constructed could switch from a first state at a first low temperature to a second state at a high temperature that serves to reduce the energy (e.g., heat) load to the building at high temperatures. Roofing substrates containing the composite decrease the heat load to the building by reflecting heat at high temperatures and absorbing energy at low or cool temperatures. Similar arrangements could be used with vehicles, textiles, parking lots and other materials and devices.

While preferred embodiments of the present invention have been shown and described, it will be apparent to those of ordinary skill in the art that many changes and modifications may be made without departing from the invention in its true scope and broader aspects. The appended claims are therefore intended to cover all such changes and modifications as fall within the spirit and scope of the invention.

What is claimed is:

1) An optically modifiable composite material comprising a first material and a second material wherein the composite has a maximum transparency at a first temperature when a refractive index of the second material matches a refractive index of the first material and an opaque quality at a second temperature when the refractive index of the second material and the refractive index of the first material are not matched whereby the composite reversibly transitions between transparent and opaque as temperatures fluctuate.

2) The optically modifiable composite material of claim 1 wherein the second material and the first material are intermixed.

3) The optically modifiable composite material of claim 1 wherein the first material therein has a thermo-optic coefficient between about −8E10⁻⁵ to about −5E10⁻³.

4) The optically modifiable composite material of claim 1 wherein the second material has a thermo-optic coefficient between about +5E10⁻⁷ to about −8E10⁻⁵.

5) The optically modifiable composite material of claim 1 wherein the second material comprises glass.

6) The optically modifiable composite material claim 5 wherein the first material comprises a polymer.

7) The optically modifiable composite material of claim 1 wherein the ordered index matched phase material comprises less than 50% of the second material by volume.

8) The optically modifiable composite material of claim 7 wherein the ordered index matched phase material further comprises a tuning agent that tunes the thermal response of the composite as a function of temperature.

9) The optically modifiable composite material of claim 1 wherein the first material and the second material are layered.

10) A construction material comprising:
an optically modifiable composite material comprising an ordered index-matched phase material having a first material and a second material wherein the composite has a maximum transparency at a first temperature when a refractive index of the second material matches a refractive index of the first material and an opaque quality at a second temperature when the refractive index of the second material and the refractive index of the first material are not matched whereby the composite reversibly transitions between transparent and opaque as temperatures fluctuate.

11) The construction material of claim 10 wherein the ordered index-matched phase material comprises glass particles

12) The construction material of claim 10 wherein the ordered index-matched material comprises a polymer

13) The construction material of claim 10 wherein the construction material is a window.

14) The construction material of claim 10 wherein the construction material is a coating.

15) The construction material of claim 10 wherein the construction material is a roofing material.

16) The construction material of claim 10 wherein the construction material is a paving material.

17) The construction material of claim 10 wherein the first material and the second material are intermixed.

18) The construction material of claim 10 wherein the materials are layered.

19) A method of making a an optically modifiable composite material comprising an ordered index-matched phase material having a first material embedded within a second material wherein the composite has a maximum transparency at a first temperature when a refractive index of the matrix material matches a refractive index of the filler material and an opaque quality at a second temperature when the refractive index of the filler material and the refractive index of the matrix material are not matched whereby the composite reversibly transitions between transparent and opaque as temperatures vary, the method comprising the steps of: mixing a preselected amount of a transparent filler material into a preselected quantity of a transparent matrix material filler material to form a composite.
